(19) United States
(12) Patent Application Publication
(10) Pub. No.: US 2005/0218540 A1
(43) Pub. Date: Oct. 6, 2005

(54) Process for preparing micron/nano size inorganic particles

(75) Inventors: Murali Sastry, Pune (IN); Debabrata Rautaray, Pune (IN); Kaustav Sinha, Pune (IN)

Correspondence Address: William R. Evans;Ladas & Parry, 26 West 61 Street, New York, NY, 10023, US

(73) Assignee: Council of Scientific and Industrial Research

(21) Appl. No.: 10/814,856

(22) Filed: Mar. 31, 2004

(51) Int. Cl. B29B 9/00

(52) U.S. Cl. 264/10; 264/11

(57) ABSTRACT

The present invention discloses methods for making micron/nano sized (2 nm to 5 μm) particles of various inorganic materials such as mineral/oxides/sulphides/metals/ceramics using aqueous foam, Aqueous foams of various anionic, cationic, non-ionic surfactant, casein proteins and their mixtures has been used for the preparation of suitable inorganic materials growth. Large scale synthesis of advanced inorganic materials such as various ceramics, minerals, oxides, sulphides and metal micron/nanoparticles of controlled shape and size can be obtained by mixing appropriate metal ions with the suitable cationic/anionic/non-ionic/casein protein/their mixtures, which is bubbled by air to form aqueous foams and thereafter their reduction/reaction to form the final product.

### FIELD OF THE INVENTION

The present invention relates to a process for preparing micron/nano sized inorganic particles having a particle size in the range of 2 nm to 5 μm, More particularly, the present invention relates to a method for producing micro/nano-sized (2 nm to 5 μm) particles of minerals/ceramics/sulphides/oxides and metals by using a novel aqueous foaming technique. This development of protocol for the large-scale preparation of various inorganic materials with control over crystallographic structure, size and morphology, is often driven by numerous technological and medical applications. Micron/nano size particles formed by this process can be used for several technological and medical applications, e.g., advanced ceramics, catalysts, filler materials, sensors, semiconductors, pigments, and can also be used in plastic industries, paper industries and several other industries.

### BACKGROUND OF THE INVENTION

Chemical and material synthesis and transformation is a core industry in the world economy. Various techniques have been developed for large-scale generation of advanced inorganic materials of controllable structure and size, some based on physical and some on chemical principles. Numerous substances are synthesized using processes that require non-ambient temperatures and/or non-ambient pressures that require capital-intensive equipment. Methods that can produce useful chemicals and materials at conditions closer to ambient conditions and use simple equipments are economically, ecologically and environmentally more desirable. Significant research efforts have been devoted for nanostructure processing as a means to achieve materials having commercial requirements in areas as diverse as electronics, pigments, cosmetics, ceramics and medical industries, (Mann et al, Nature, 1996, 382, 313; Matijevic et al, Curr. Opin. Colloid Interface Sci., 1996, 1, 176).

Langmuir monolayers have been shown to induce oriented crystallization from solutions of proteins (Uzgiris and Kornberg et al Nature, 1983, 301, 125; Ahlers et al Thin Solid Films, 1989, 180, 93) and other organic and inorganic compounds (Landau et al Nature, 1985, 318, 353). Mann, et al have studied the oriented crystallization of CaCO₃ under monolayers of stearic acid (Mann et al, Nature, 1988, 334, 692; Mann et al Nature, 1988, 332, 119). Heywood and Mann have studied the oriented nucleation of BaSO₄ under compressed Langmuir monolayers of long chain alkyl phosphonate resulted in plate-like out growth as well as bow-tie morphology (Heywood and Mann et al Langmuir (1992, 8, 1492) and under n-eicosyl sulfate/eicosanoic acid monolayer resulted in unusual and complex morphology of BaSO₄ crystals (Heywood and Mann et al J. Am. Chem. Soc., 1992, 114, 4681). In biomimetic template such as self assembled monolayers (SAMs), Aizenberg, Black and Whitesides have shown that orientational match between carboxylate ions in SAMs and carbonate ions in the calcite nucleating phase is more important (Aigenberg et al, J. Am. Chem. Soc. 1999, 121, 4500). This often leads to the oriented growth of CaCO₃ crystals on surfaces such as terminally functionalized SAMs supported on metal films. (Kuther et al Chem. Eur. J. 1998, 4, 1834; Aigenberg et at, J. Am. Chem. Soc. 1999, 121, 4500). Travaille et al. have shown interesting hexagonal organization of highly oriented calcite crystals on Au (111) films covered by a monolayer of 16-mercaptohexadecanoic acid (Travaille et al Adv. Mater. 2002,14, 492).

It is also already shown that metal ions entrapped in lipid bilayer stacks can be chemically reacted to yield a variety of materials within the confines of the bilayer stacks. One interesting possibility is the growth of minerals within the bilayer stacks by suitable reaction of entrapped metal cations. Sastry et al have reported on the growth of BaSO₄ (Sastry et al, Cryst. Growth and Des. 2002, 2, 197), SrCO₃ (Sastry et al Cryst. Eng. Comm. 2001, 21, Sastry et al. Langmuir 2003, 19, 888) and CaCO₃ (Sastry et al Langmuir 2002, 18, 6075) crystals within thermally evaporated stearic acid and aerosol OT thin films and have observed controlled morphology and assembly of barite, strontianite needles and highly oriented growth of calcite crystals mediated by the fatty lipid host.

Various polymeric templates have been reported to grow controlled inorganic material. Yu et al have reported highly ordered funnel-like BaCrO₄ and long BaSO₄ fiber bundles by using sodium polyacrylate as crystal growth modifiers (Yu et al, Nano Lett, 2003, 3 379). Yu et al have also reported on the morphogenesis of BaCrO₄ by using double hydrophilic block copolymers (DHBCs) as crystal growth modifiers. (Yu et al, Chem. Eur. J, 2002, 8, 2937). Donners et al. have demonstrated the use of a shape persistent polymeric crystallization template [poly (L-isocyanoalanyl-D-alanine)] in the growth of calcite wherein crystal growth was influenced both by nucleation and adsorption processes (Donners et al J. Am. Chem. Soc. 2002, 124, 9700). U.S. Pat. No. 5,578,325, U.S. Pat. No. 5,565,188 and U.S. Pat. No. 6,007,845 discusses on the role of non-linear hydrophilic-hydrophobic multiblock copolymers for the formation of nano and micro particles.

Suitably designed additives in solution during crystal growth have also been used with success in controlling the morphology and structure of ceramic crystals. Various efforts have been made in the fabrication of highly crystalline gallium oxide nano tubes, wires and brushes using molten gallium and microwave plasma treatment (Sharma et al, J. Am. Chem. Soc., 2002, 124, 12288), hierarchical ZnO nanostructures by vapor transport and condensation technique (Lao et al, Nano Lett., 2002, 2, 1287).

Organic matrices are being increasingly investigated for the controlled growth of metal nano particles either at the air-water interface (Fendler et al, J. Phys. Chem. 1994, 98, 387; Fendler et al, J. Phys. Chem. 1995, 99, 5500) or by chemical insertion into Langmuir-Blodgett (LB) films (Urquhart et at, Langmuir 1995, 11, 1127, Leloup et al, Thin Solid Films 1992, 210, 407). Multilayer lamellar films of clusters have also been successfully grown by the LB technique by electrostatic immobilization of the colloidal particles in Langmuir monolayers. (Fendler et al, J. Phys. Chem. 1994, 98, 4913; Sastry et al, J. Phys. Chem. B. 1997, 101, 4954).

Inorganic crystal growth has also been carried out using constrained environments such as those afforded by microemulsions (Hopwood and Maim et al, Chem., Mater, 1997, 9, 950; Li and Mann, Langmuir, 2000, 16, 7088; Hopwood and Mann, Chem. Mater, 1997, 9, 1819). The anionic surfactant AOT has been used in the synthesis of nanoparticles of barium chromate (Li and Mann et al, Nature, 1999, 402, 393), barium sulfate, (Hopwood and Mann et al, Chem. Mater, 1997, 9, 1819; Li and Mann et al, Langmuir, 2000, 16, 7088), calcium sulfate (Rees et al, Langmuir, 1999, 15, 1993), barium carbonate (Qi et al, J. Phys. Chem. B, 1997, 101, 3460) and silica (Arriagada et al, J. Colloid lnterface Sci, 1995, 170, 8). Attempts has also been made to synthesize oxides such as zinc oxide (Lao et al, Nano Lett., 2002, 2, 1287), gallium oxide (Sharma et al, J. Am. Chem. Soc., 2002, 124, 12288), ceramics such as BaCrO₄ (Yu et al, Nano Lett., 2003, 3, 379; Yu et al, Chem. Eur. J., 2002, 8, 2937) and BaSO₄ (Li and Mann et al, Nature, 1999, 402, 393; Hopwood and Mann et al, Chem. Mater., 1997, 9, 1819; Li and Mann et al, Langmuir, 2000, 16, 7088) in microemulsions where interactions between surfactant molecules coating the crystallites were implicated in the assembly process.

U.S. Pat. No. 6,264,741 used the amphiphilic nature of surfactant molecules to simultaneously organize inorganic and organic precursors into highly ordered nano-structured films and particles in a rapid, evaporation-driven, self-assembly process for the preparation of various nano composite materials. U.S. Pat. No. 5,338,334 teaches a process for the preparation of metal nano particles which were physically impregnated in to polymeric foams to obtain desired submicron and nano ceramic powder after calcination of the polymeric foam.

To reduce complexity of mentioned processes and to enhance large-scale production of these micron/nano-sized inorganic particles such as metals/oxides/minerals/sulphides/ceramics, a very efficient and simple chemical route has been invented, in which materials of controllable structure, size and shape can be synthesised using various surfactant based aqueous foams. In this technique, metal cation/anion salts of the desired mineral/oxide/sulphide/ceramic/metal composition are dissolved in water and the metal cation/anion solution is then homogeneously mixed with the suitable surfactant used to produce the aqueous foam. Thereafter, the respective metal cation/anion is reduced/reacted within the foam cell structure to produce the desired mineral/metal/ceramic/sulphide/oxide micron/nano size particles. Aqueous foams of various anionic, cationic, non-ionic surfactant, casein proteins and their mixtures can be used for the preparation of suitable inorganic materials growth.

The prior art methods for the growth of various inorganic materials teach us to grow a wide variety of these particles together with the control over their crystal size, shape and morphology but have certain limitations.

The major drawbacks of the prior ant processes are:
1. Large-scale synthesis is not possible
2. Uniform size control is tough
3, Complex experimental conditions
4. High temperature treatment to foam column
5. Require more manoeuvring
6. Not a robust system
7. Not cost effective
8. Stability of the system is low
9. There is an upper limit to scaling m terms of mass production
10. Possibility of contamination is high if proper care is not taken.

The present invention considerably simplifies the process for the large-scale synthesis of various crystalline inorganic materials with controlled shape, size and morphology thereof By changing simple parameters within the system it is possible to control the shape, size and morphology. The surfactant solution in this case is reusable for making huge quantities of a particular inorganic material.

All publications and patents mentioned in the above specification are incorporated herein by reference.

Objects of the Invention

The main object of this invention is to produce micron/nano size particles ranging from 2 nm to 5 μm of various inorganic materials,

Another object of this invention to produce micron/nano size particles ranging from 2 nm to 5 μm of various inorganic materials on a large scale.

Yet another object of this invention to produce micron/nano size particles (2 nm to 5 μm) of various inorganic materials without introducing impurities into them.

Still another object of this invention to provide a process for preparing micron/nano size particles (2 nm to 5 μm) of various inorganic materials, which do not require calcination.

A further object of this invention to provide a process for preparing micron/nano size particles (2 nm to 5 μm) of various inorganic materials in which the conditions for preparation are not critical to the resulting particles of various inorganic materials.

Yet another object of this invention to provide a process for preparing micron/nano size ((2 nm to 5 μm) ceramic/metal/mineral/sulphide/oxide particles, which is essentially dependent of the chemical concentration of the ceramic/metal/mineral/sulphide/oxide particles to be synthesized,

Still another object of this invention to produce ceramic/metal/mineral/sulphide/oxide particles which are free of agglomerates and uniform in size,

Another object of this invention to provide a process for preparing micron/nano size particles (2 nm to 5 μm) of various inorganic materials in stoichiometry is easily controlled,

Still another object where aqueous foams of various anionic, cationic, non-ionic surfactant, casein proteins and their mires are used for the preparation of suitable inorganic materials growth.

Yet another object of this invention to provide a generic, low-cost process for producing high purity, micron/nano size, single or multi-component particles of various inorganic materials.

Still another object of this invention to produce particles of various inorganic materials, which are chemically uniform.

### SUMMARY OF THE INVENTION

The above and other objects are achieved by the present invention to grow micron/nano-sized inorganic particles (2 nm to 5 μm) such as metals/oxides/minerals/sulphides/ceramics using a very efficient chemical route where materials of controllable structure, size and shape can be synthesised using various aqueous foams. In this technique, metal cation/anion salts of the desired mineral/oxide/sulphide/ceramic/metal composition are dissolved in water and the metal cation/anion solution is then homogeneously mixed with he suitable surfactant used to produce the aqueous foam. There after, the respective metal cation/anion is reduced/reacted within the foam cell structure to produce the desired mineral/metal/ceramic/sulphide/oxide micron/nano size particles (2 nm to 5 μm). The particles produced in accordance with this process are highly pure, uniform, agglomerate-free, single or multi component micron/nano-size particles of various inorganic materials. Particles produced in accordance with this process range in size from 2 nm to 5 μm.

In the present invention, metal cation/anion salts of desired mineral/oxide/sulphide/ceramic/metal composition are dissolved in water and the metal cation/anion solution is then homogeneously mixed with the suitable surfactant used to produce aqueous foam. There after, the respective metal cation/anion was reduced or reacted needed to produce the desired mineral/metal/ceramic/sulphide/oxide micron/nano size particles.

Using surfactant based aqueous foam, such as AOT based foam, provides support for the metal cations solution so that metal cations are dispersed within the foam cell structure.

In one of the features of this invention, the physical characteristics of the aqueous foam structure, such as density, pore size and pore shape can also be used to control the particle size and morphology of the particles of various inorganic materials. Primary control over particle size and morphology is determined by the concentration of the metal cations/anions and also that of the surfactant.

Particles of various inorganic materials produced in accordance with one embodiment of the process of this invention have generally uniform particle sizes ranging from several nanometres to one micrometer, have no agglomerates and thus require no grinding and calcination, and do not contain significant impurities introduced by the process.

Yet another feature of this invention, the aqueous foam comprising the metal cations/anions homogeneously incorporated within the foam cell structure is produced by mixing an aqueous solution comprising at least one metal cation/anion salt with a surfactant producing a metal salt/surfactant mixture, generating bubbles within the metal salt/surfactant mixture to form a wet foam structure. There after, the foam containing metal cation/anion with the appropriate surfactants was reduced or reacted to produce the desired mineral/metal/ceramic/sulfide/oxide micron/nano size particles ranging from 2 nm to 5 μm.

### DESCRIPTION OF THE INVENTION

Accordingly the present invention provides a new process for the preparation of micron/nano sized inorganic particles (2 nm to 5 μm) using aqueous foams which comprises mixing an aqueous solution of a base inorganic salt or a mixture of at least two base inorganic salts with a foaming surfactant oppositely charged to the base inorganic salt, aerated to form a column of foam, reducing the inorganic salt particles in the column of foam either by spraying or by exposing it to a reducing agent/atmosphere so as to form the nanoparticles of the corresponding inorganic material of the base inorganic salt, allowing to settle with the gradual collapsing of the foam and collecting the nanoparticles by spraying distilled water over the column of foam, drying the nanoparticles by conventional methods.

In one of the embodiments of the present invention the base inorganic salts are selected from salts of calcium, barium, strontium, chromium yttrium, aluminium lithium, iron, antimony, boron, cadmium, cesium, silver, mercury, cobalt, sodium, thorium, tin, indium, tungsten, vanadium, manganese, copper, lead and their mixtures thereof.

In yet another embodiment the base inorganic salts is preferably chloroaurate, chloroplatinate, tetrachloronickelate, chloropalladate, hexaflourotitante, hexaflouoro zirconate, phosphotungstate, phosphomolybdate, silicotungstate and their mixtures thereof.

In still another embodiment the foaming surfactant is preferably aqueous foams of various anionic, cationic, non-ionic surfactant and mixtures thereof exemplified bysodium alkyl sulfates, sodium bis-2-ethyl-hexyl sulfosuccinate, alkyl triethylammonium bromides, alkyl polyoxyethylene monoethers, casein proteins, and their mixtures.

In still another embodiment the foam, has means a material having porosity between about 60%A and 99%, the porosity meaning the void space within the foam structure.

In a feature of the present invention the micron/n sized particles as described herein are generally uniform in shape and, more preferably, substantially spherical particles ranging in size from several nanometres to one micron in diameter.

This invention may further be illustrated by way of the following examples which are illustrative and should not be construed as limiting the scope of the invention in any manner.

Experimental Details

### EXAMPLE 1

This example illustrates the large-scale synthesis of calcium carbonate crystallites of size ranging from 10 nm to 5 μm, using aqueous foam, The foam preparation set-up used in this case is a rectangular column with two apertures at the square base having the capacity to hold approximately 500 cc of foam. A 100 mL solution of 10⁻³ M aqueous calcium chloride was added to the 100 mL solution of 10⁻² M solution of sodium bis-2-ethylhexyl-sulfosuccinate (AOT) dissolved in water. This solution was poured in the rectangular column and the foam was built up by injecting air at a pressure within the range of 1-10 psig, through a circular sintered disc or frit. After stabilization of foam the AOT and the calcium chloride solution was drained out and the foam column was exposed to the carbon dioxide chamber. The foam collapsed gradually and the crystals of calcium carbonate were collected through the outlet provided at the bottom of the column. The crystals formed were transferred onto Si (111) and glass substrates for further analysis. An average particle size of about several nm-few microns was observed using a high resolution SEM.

### EXAMPLE 2

This example illustrates the large-scale synthesis of calcium carbonate crystallites of size ranging from 10 nm to 5 μm, using aqueous foam. The foam preparation set-up used in this case is a rectangular column with two apertures on the square base having the capacity to hold approximately 500 cc of foam. A 100 mL solution of 5×10⁻³ M aqueous calcium chloride was added to the solution of 10⁻² M sodium bis-2-ethylhexyl-sulfosuccinate (AOT) dissolved in water. This solution was poured in the rectangular column and the foam was built up by injecting air at a pressure of 1-10 psig, through a sintered disc or frit. After stabilization of the foam column the AOT and calcium chloride solution was drained out through the outlet provided at the bottom of the column. Once the solution was filly drained out, 100 ml solution of 10⁻³ M of sodium carbonate was sprayed uniformly from the top of the column. The foam collapsed gradually and the crystals of calcium carbonate were collected through the outlet provided at the bottom of the column. The crystals formed in were transferred onto Si (111) and glass substrates for further analysis. An average particle size of about 10 nm to 5 m was observed using a high resolution SEM.

### EXAMPLE 3

This example illustrates the large-scale synthesis of calcium carbonate crystallites of size ranging from 10 nm to 5 μm, using aqueous foam. The foam preparation set-up used in this case is a rectangular column with two apertures at the square base having the capacity to hold approximately 500 cc of foam. A 100 mL solution of 10⁻³ M aqueous calcium chloride was added to the 100 mL solution of 10⁻¹ M Sodium Dodecyl Sulphate (SDS) dissolved in water. This solution was poured in the rectangular column and the foam was built up by injecting air at a pressure within the range of 1-10 psig, through a circular sintered disc or frit. After stabilization of foam the SDS and the calcium chloride solution was drained out and the foam column was exposed to the carbon dioxide chamber. The foam collapsed gradually and the crystals of calcium carbonate were collected through the outlet provided at the bottom of the column. The crystals formed in the control experiments were transferred onto Si (111) and glass substrates for further analysis. An average particle size of about 10 nm to 5 μm was observed using a high resolution SEM.

### EXAMPLE 4

This example illustrates the large-scale synthesis of calcium carbonate crystallites of size ranging from 10 nm to 5 μm, using aqueous foam. The foam preparation set-up used in this case is a rectangular column with two apertures on the square base having the capacity to hold approximately 500 cc of foam. A 100 mL of 10⁻³ M aqueous solution of calcium chloride was added to the 100 mL of 10⁻¹ M solution of Sodium Dodecyl Sulphate (SDS) dissolved in water. This solution was poured in the rectangular column and the foam was built up by injecting air at a pressure of 1-10 psig, through a sintered disc or it. Foaming occurred in about 150 seconds and after one minute of the foam column being stable the SDS and the calcium chloride solution was drained out through the outlet provided at the bottom of the column. Once the solution was fully drained out, 100 mL solution of 10⁻³ M aqueous sodium carbonate was sprayed uniformly from the top of the column. The foam collapsed gradually and the crystals of calcium carbonate were collected through the outlet provided at the bottom of the column. The crystals formed in were transferred onto Si (111) and glass substrates for further analysis. An average particle size of about 10 nm to 5 μm was observed using a high resolution SEM.

### EXAMPLE 5

This example illustrates the large-scale synthesis of calcium carbonate crystallites of size ranging from 10 nm to 5 μm, using aqueous foam. The foam preparation set-up used in this case is a rectangular column with two apertures on the square base having the capacity to hold approximately 500 cc of foam. A 100 mL of 10⁻³ M aqueous solution of sodium carbonate was added to the 100 mL of 10⁻¹ M solution of Cetyl tetra ammonium bromide (CTAB) dissolved in water. This solution was poured in the rectangular column and the foam was built up by injecting air at a pressure of 1-10 psig, through a sintered disc or frit. After stabilization of the foam column the CTAB and the sodium carbonate solution was drained out through the outlet provided at the bottom of the column. Once the solution was fully drained out, 100 mL solution of 10⁻³ M aqueous calcium chloride was sprayed uniformly from the top of the column. The foam collapsed gradually and the crystals of calcium carbonate were collected through the outlet provided at the bottom of the column. The crystals formed in were transferred onto Si (111) and glass substrates for further analysis. An average particle size of about 10 nm to 5 μm was observed using a high resolution SEM.

### EXAMPLE 6

This example illustrates the large-scale synthesis of strontium carbonate crystallites of size 10 nm to 5 μm in the presence of foam. The foam preparation set-up used in this case is a rectangular column with two apertures on the square base having the capacity to hold approximately 500 cc of foam. A 100 mL of 5×10⁻³ M aqueous strontium chloride was added to the 100 mL solution of 10⁻² M aerosol-OT (AOT) dissolved in water. This solution was poured in the rectangular column and the foam was built up by injecting air at a pressure of 1-10 psig, through a sintered disc or frit. Foaming occurred in about 120 seconds and after one minute of the foam column being stable the AOT and the strontium chloride solution was drained out through the outlet provided at the bottom of the column. Once the solution was filly drained out, 100 ml solution of 10⁻³ M aqueous sodium carbonate was sprayed uniformly from the top of the column. The foam collapsed gradually and the crystals of strontium carbonate were collected through the outlet provided at the bottom of the column. The crystals formed in were transferred onto Si (111) and glass substrates for further analysis. An average particle size of about 10 nm to 5 μm was observed using a high resolution SEM.

### EXAMPLE 7

This example illustrates large-scale synthesis of barium sulphate of size 10 nm to 5 μm crystallites in the presence of foam. The foam preparation set-up used in this case is a rectangular column with two apertures at the square base having the capacity to hold approximately 500 cc of foam. A 100 mL aqueous solution of 5×10⁻³ M barium chloride was added to 100 mL solution of 10⁻² M aerosol-OT (AOT) dissolved in water. This solution was poured in the rectangular column and the foam was built up by injecting air at a pressure of 1-10 psig, through a sintered disc or frit. After stabilization of the foam column the AOT and the barium chloride solution was drained out through the outlet provided at the bottom of the column. Once the solution was fully drained out, 100 mL solution of 10⁻³ M sodium sulphate was sprayed uniformly from the top of the column. The foam collapsed gradually and the crystals of barium sulphate were collected through the outlet provided at the bottom of the column. The crystals formed in were transferred onto Si (111) and glass substrates for further analysis. An average particle size of about 10 nm to 5 μm was observed using a high resolution SEM.

### EXAMPLE 8

This example illustrates the large-scale synthesis of barium chromate of size 10 nm to 5 μm crystallites in the presence of foam. The foam preparation set-up used in this case is a rectangular column with two apertures on the square base having the capacity to hold approximately 500 cc of foam. A 100 mL aqueous solution of 5×10⁻³ M barium chloride was added to 100 mL solution of of 10⁻² M aerosol-OT (AOT) dissolved in water. This solution was poured in the rectangular column and the foam was built up by injecting air at a pressure of 1-10 psig, through a sintered disc or frit. After stabilization of the foam column the AOT and the barium chloride solution was drained out through the outlet provided at the bottom of the column. Once the solution was fully drained out, 100 mL solution of 10⁻³ M aqueous potassium chromate was sprayed uniformly from the top of the column. The foam collapsed gradually and the crystals of barium chromate were collected through the outlet provided at the bottom of the column. The crystals formed in were transferred onto Si (111) and glass substrates for further analysis. An average particle size of about 10 nm to 5 μm was observed using a high resolution SEM.

### EXAMPLE 9

This example illustrates the large-scale synthesis of silver crystallites of size 5 nm to 500 nm in the presence of foam. The foam preparation set-up used in this case is a rectangular column with two apertures on the square base having the capacity to hold approximately 500 cc of foam. A 100 mL solution of 10⁻⁴ M aqueous silver sulphate was added to 100 mL solution of 10⁻¹ M Sodium Dodecyl Sulphate (SDS), dissolved in water. This solution was poured in the rectangular column and the foam was built up by injecting air at a pressure of 1-10 psig, through a sintered disc or frit. After stabilization of foam the SDS and the silver sulphate solution was drained out and the foam column was exposed to the hydrazine vapour atmosphere. The crystals formed in were transferred onto Si (111) and glass substrates for further analysis. An average particle size of about 5 nm to 500 nm was observed using high resolution SEM.

### EXAMPLE 10

This example illustrates the large-scale synthesis of platinum crystallites of size 5 nm to 500 nm in the presence of foam. The foam preparation set-up used in this case is a rectangular column with two apertures on the square base having the capacity to hold approximately 500 cc of foam. A 100 mL solution of 10⁻⁴ M aqueous platinum chloride was added to 100 mL; solution of 10⁻¹ M Cetyl tetra ammonium bromide (CTAB), dissolved in water. This solution was poured in the rectangular column and the foam was built up by injecting air at a pressure of 1-10 psig, through a sintered disc or frit. In this case the foam was built in the presence of hydrazine vapour atmosphere. After one minute of the foam column being stable the CTAB and the platinum chloride solution was drained out through the outlet provided at the bottom of the column. Once the foam collapsed the crystals of gold were collected through the outlet provided at the bottom of the column. The crystals formed in were transferred onto Si (111) and glass substrates for further analysis. An average particle size of gold about 5 nm to 500 nm was observed using high resolution SEM.

### EXAMPLE 11

This example illustrates the large-scale synthesis of gold crystallites size 5 nm to 500 nm in the presence of foam. The foam preparation set-up used in this case is a rectangular column with two apertures on the square base having the capacity to hold approximately 500 cc of foam. A 100 mL solution of 10⁻⁴ M gold chloride dissolved in water was added to 100 mL solution of 10⁻¹ M Cetyl tetra ammonium bromide (CTAB), also dissolved in water. This solution was poured in the rectangular column and the foam was built up by injecting air at a pressure of 1-10 psig, through a sintered disc or frit. In this case the foam was built in the presence of hydrazine vapour atmosphere. After the stabilization of the foam column the CTAB and gold chloride solution was drained out through the outlet provided at the bottom of the column. Once the foam collapsed the crystals of gold were collected through the outlet provided at the bottom of the column. The crystals formed in were transferred onto Si (111) and glass substrates for further analysis. An average particle size of gold about 5 nm to 500 nm was observed using high resolution SEM.

### EXAMPLE 12

This example illustrates the large-scale synthesis of cadmium sulphide (CdS) crystallites of size 5 nm to 500 mm in the presence of foam. The foam preparation set-up used in this case is a rectangular column with two apertures on the square base having the capacity to hold approximately 500 cc of foam. A 100 mL solution of 10⁻³ M aqueous cadmium chloride dissolved in water was added to 100 mL solution of 10⁻¹ M Sodium Dodecyl Sulphate (SDS) dissolved in water. This solution was poured in the rectangular column and the foam was built up by injecting air at a pressure of 1-10 psig, through a sintered disc or frit. After stabilization of foam the SDS and the cadmium chloride solution was drained out and the foam column was exposed to the sulphide vapour atmosphere. The crystals formed in were transferred onto Si (111) and glass substrates for further analysis. An average particle size of about 5 to 500 nm was observed using high resolution SEM.

### EXAMPLE 13

This example illustrates the large-scale synthesis of cadmium sulphide (CdS) crystallites 2 nm to 500 nm in the presence of foam. The foam preparation set-up used in this case is a rectangular column with two apertures on the square base having the capacity to hold approximately 500 cc of foam. A 100 mL solution of 10⁻³ M aqueous cadmium chloride dissolved in water was added to 100 mL solution of 10⁻² M sodium bis-2-ethylhexyl-sulfosuccinate (AOT) dissolved in water. This solution was poured in the rectangular column and the foam was built up by injecting air at a pressure of 1-10 psig, through a sintered disc or frit. After stabilization of foam the AOT and the cadmium chloride solution was drained out and the foam column was exposed to the sulphide vapour atmosphere. The crystals formed in were transferred onto Si (111) and glass substrates for further analysis. An average particle size of about 2 nm to 500 nm was observed using high resolution SEM.

### EXAMPLE 14

This example illustrates the large-scale synthesis of zinc sulfide (ZnS) of size 2 nm to 500 nm crystallites in the presence of foam. The foam preparation set-up used in this case is a rectangular column with two apertures on the square base having the capacity to hold approximately 500 cc of foam: A 100 mL solution of 10⁻³ M aqueous zinc chloride dissolved in water was added to 100 mL solution of 10⁻² M sodium bis-2-ethylhexyl-sulfosuccinate (AOT) dissolved in water. This solution was poured in the rectangular column and the foam was built up by injecting air at a pressure of 1-10 psig, through a sintered disc or frit. After stabilization of foam the AOT and the zinc chloride solution was drained out and the foam column was exposed to the sulfide vapour atmosphere. The crystals formed in were transferred onto Si (111) and glass substrates for further analysis. An average particle size of about 2 nm to 500 nm was observed using high resolution SEM.

### EXAMPLE 15

This example illustrates the large-scale synthesis of titanium oxide crystallites of size 2 nm to 500 nm in the presence of foam. The foam preparation set-up used in this case is a rectangular column with two apertures on the square base having the capacity to hold approximately 500 cc of foam. A 100 mL solution of 10⁻³ M aqueous K₂TiF₆ was added to 100 mL solution of 10⁻² M Cetyl tetra ammonium bromide (CTAB) dissolved in water. This solution was poured in the rectangular column and the foam was built up by injecting air at a pressure of 1-10 psig, through a sintered disc or frit. After one minute of the foam column being stable the CTAB and the K₂TiF₆ solution was drained out through the outlet provided at the bottom of the column. Once the solution was fully drained out, 100 mL solution of 10⁻⁵ M ammonia solution was sprayed uniformly from the top of the column. Once the foam collapsed the titanium oxide particles were collected through the outlet provided at the bottom of the column. The crystals formed in were transferred onto Si (111) and glass substrates for further analysis. An average particle size of gold about 2 nm to 500 nm was observed using high resolution SEM.

### EXAMPLE 16

This example illustrates the large-scale synthesis of bimetallic crystallites 10 nm to 500 nm such as gold-silver bimetallic in the presence of foam. The foam preparation set-up used herein is a rectangular column with two apertures on the square base having the capacity to hold approximately 500 cc of foam. A mixture of 100 mL aqueous solution of 10⁻⁴ M gold chloride and silver sulfate solution dissolved in water was added to 100 mL solution of 10⁻² M Cetyl tetra ammonium bromide (CTAB), also dissolved in water. This solution was poured in the rectangular column and the foam was built up by injecting air at a pressure of 1-10 psig, through a sintered disc or frit. In this case the foam was built in the presence of hydrazine vapour atmosphere. After one minute of the foam column being stable the CTAB and the mixture of gold chloride and silver sulfate solution was drained out through the outlet provided at the bottom of the column. Once the foam collapsed the crystals of gold were collected through the outlet provided at the bottom of the column. The crystals formed in were transferred onto Si (111) and, glass substrates for further analysis. An average particle size of gold about 10 nm to 500 nm was observed using high resolution SEM.

### EXAMPLE 17

This example illustrates the large-scale synthesis of bimetallic crystallites 10 nm to 500 nm such as gold-platinum bimetallic in the presence of foam. The foam preparation set-up used in this case is a rectangular column with two apertures on the square base having the capacity to hold approximately 500 cc of foam. A mixture of 100 mL solution of 10⁻⁴ M aqueous gold chloride and platinum chloride solution was added to 100 mL solution of 10⁻² M Cetyl tetra ammonium bromide (CTAB), also dissolved in water. This solution was poured in the rectangular column and the foam was built up by injecting air at a pressure of 1-10 psig, through a sintered disc or frit. In this case the foam was built in the presence of hydrazine vapour atmosphere. After one minute of the foam column being stable the CTAB and the mixture of gold chloride and platinum chloride solution was drained out through the outlet provided at the bottom of the column. Once the foam collapsed the crystals of gold were collected through the outlet provided at the bottom of the column. The crystals formed in were transferred onto Si (111) and glass substrates for further analysis. An average particle size of gold about 10 nm to 500 nm was observed using high resolution SEM.

### EXAMPLE 18

This example illustrates the large-scale synthesis of bimetallic crystallites 10 nm to 500 nm such as gold-palladium bimetallic in the presence of foam. The foam preparation set-up used in this case is a recta column with two apertures on the square base having the capacity to hold approximately 500 cc of foam. A mixture of 100 mL solution of 10⁻⁴ M aqueous gold chloride and palladium chloride solution was added to 100 mL solution of 10⁻² M Cetyl tetra ammonium bromide (CTAB), also dissolved in water. This solution was poured in the rectangular column and the foam was built up by injecting air at a pressure of 1-10 psig, through a sintered disc or frit. In this case the foam was built in the presence of hydrazine vapour atmosphere. After one minute of the foam column being stable the CTAB and the mixture of gold chloride and palladium chloride solution was drained out through the outlet provided at the bottom of the column. Once the foam collapsed the crystals of gold were collected through the outlet provided at the bottom of the column. The crystals formed in were transferred onto Si (111) and glass substrates for further analysis. An average particle size of gold about 10 nm to 500 nm was observed using high resolution SEM.

### EXAMPLE 19

This example illustrates the large-scale synthesis of calcium carbonate crystallites 5 nm to 5 μm using aqueous foam. The foam preparation set-up used in this case is a rectangular column with two apertures at the square base having the capacity to hold approximately 500 cc of foam. A 100 mL solution of 5×10³ M aqueous calcium chloride was added to the 10⁻⁴ M solution of beta casein protein dissolved in water. This solution was poured in the rectangular column and the foam was built up by injecting air at a pressure within the range of 1-10 psig, through a circular sintered disc or frit. After stabilization of foam the casein protein and the calcium chloride solution was drained out and the foam column was exposed to the carbon dioxide chamber. The foam collapsed gradually and the crystals of calcium carbonate were collected through the outlet provided at the bottom of the column. The crystals formed in the control experiments were transferred onto Si (111) and glass substrates for further analysis. An average particle size of about 5 nm to 5 μm was observed using a high resolution SEM.

While in the foregoing specification, this invention has been described in relation to certain preferred embodiments thereof and many details have been set forth for purpose of illustration, it will be apparent to those skilled in the art that the invention is capable of additional embodiments and that certain of the details described herein can be varied considerably without departing from the basic principles of the invention.

Advantages of the process claimed in the present invention are:

1. Large scale synthesis is possible
2. Uniform size control
3. Ambient experimental conditions
4. Require less maneuvering
5. Robust system
6. Cost effective/Economical system for the industry
7. High stability of the particles formed
8. Possibility of the reusability of surfactants
9. No upper limit to scaling in terms of mass production
10. Preparation of a large variety of advanced inorganic materials is possible.

1. A process for the preparation of micron/nano sized inorganic particles (2 to 5 μm) using aqueous foams which comprises mixing an aqueous solution of a base inorganic salt or a mixture of at least two base inorganic salts with a foaming surfactant oppositely charged to the base inorganic salt, aerating the mixture to form a column of foam, reducing the inorganic salt particles in the column of foam by spraying or by exposing the foam column to to a reducing agent/atmosphere to obtain nanoparticles of the corresponding inorganic material of the base inorganic salt, allowing the foam column to settle with the gradual collapsing of the foam and collecting the nanoparticles by spraying distilled water over the column of foam and drying the nanoparticles so obtained.

2. A process as claimed in claim 1 wherein the base inorganic salts are selected from the group consisting of salts of calcium, barium, strontium, chromium, yttrium, aluminum, lithium, iron, antimony, boron, cadmium, cesium, silver, mercury, cobalt, sodium, thorium, tin, indium, tungsten, vanadium, manganese, copper, lead and any mixtures thereof.

3. A process as claimed in claim 1 wherein the base inorganic salts are selected from the group consisting of chloroaurate, chloroplatinate, tetrachloronickelate, chloropalladate, hexaflourotitante, hexaflouoro zirconate, phosphotungstate, phosphomolybdate, silicotungstate and any mixtures thereof.

4. A process as claimed in claim 1 wherein the foaming surfactant is selected from the group consisting of aqueous foams of anionic, cationic, non-ionic surfactant and any mixtures thereof.

5. A process as claimed in claim 4 wherein the foaming surfactant is selected from the group consisting of sodium alkyl sulfates, sodium bis-2-ethyl-hexyl sulfosuccinate, alkyl triethylammonium bromides, alkyl polyoxyethylene monoethers, casein protein, and any mixtures thereof.

6. A process as claimed in claim 1 wherein the foam comprises a material with porosity between about 60% and 99%.

7. A process as claimed in claim 1 wherein the micron/nano sized particles obtained are substantially uniform in shape and range in size from several nanometres to one micron in diameter.

8. A process as claimed in claim 1 wherein the size of the particles obtained is in the range of 2 nm to 5 μm.
